(19) United States
(12) Patent Application Publication
(10) Pub. No.: US 2015/0312468 A1
(43) Pub. Date: Oct. 29, 2015

(54) MULTI-CAMERA SYSTEM CONTROLLED BY HEAD ROTATION

(71) Applicant: Narvaro Inc., Stone Mountain, GA (US)

(72) Inventors: Christopher Ward Taylor, Stone Mountain, GA (US); Kevin Green, Stone Mountain, GA (US); Devin Andrews, Stone Mountain, GA (US); Tyler Sullins, Stone Mountain, GA (US)

(73) Assignee: Narvaro Inc., Stone Mountain, GA (US)

(21) Appl. No.: 14/693,289

(22) Filed: Apr. 22, 2015

Related U.S. Application Data
(60) Provisional application No. 61/983,079, filed on Apr. 23, 2014.

(51) Int. Cl. H04N 5/232; H04N 13/02; H04N 13/04; H04N 5/225; H04N 5/247

(52) U.S. Cl. CPC H04N 5/23206; H04N 5/2253; H04N 5/23293; H04N 5/247; H04N 13/0429; H04N 13/0468; H04N 13/0203; H04N 2213/001

(57) ABSTRACT

Systems and methods of controlling a remote camera system by head rotation are herein described. A sensor on a head-mounted display (HMD) can determine the orientation of the HMD. A computing device can translate the orientation of the HMD from one coordinate representation to another coordinate representation. A microcontroller can convert the orientation of the HMD to a control signal. A motor controller can orient a camera mounted gimbal based on the control signal. A plurality of cameras on the camera mounted gimbal can stream video to the HMD. A process on the HMD can process the streaming video to allow for stereoscopic vision and depth. A display on the HMD can display the processed streaming video.

### CROSS-REFERENCE TO RELATED PATENT APPLICATIONS

This application claims priority to and the benefit of the U.S. Provisional Application 61/983,097 filed Apr. 23, 2014, incorporated herein by reference in its entirety.

### BACKGROUND

Remote cameras can be used to stream a video feed to users viewing the video at displays not proximate to the remote camera. The video feed from such remote cameras can be transmitted wirelessly or via wired communications. The problem with present remote camera systems is the lack of intuitive control, low range of motion, or use of hands-on control. Furthermore, remote cameras do not offer stereoscopic vision, because remote cameras utilize a single camera. The depth perception of stereoscopic vision may be useful in controlling the systems attached to the remote camera system, such as a robot.

### SUMMARY

At least one aspect is directed to a method of controlling a remote camera system by head rotation. The method can include determining, by a sensor on a head-mounted display, an orientation of the head-mounted display. The method can include converting, by a microcontroller, the orientation of the head-mounted display to a control signal. The method can include orienting, by a motor controller, a gimbal based on the control signal. The method can include streaming, by a plurality of cameras on the gimbal, a plurality of images to the head-mounted display. The method can include processing, by a processor on the head-mounted display, the plurality of images to generate a synthesized plurality of images for stereoscopic display. The method can include displaying, by a display in the head-mounted display, the synthesized plurality of images.

At least one aspect is directed to a system for controlling a remote camera system by head rotation. The system can include a sensor on a head-mounted display that can determine an orientation of the head-mounted display. The system can include a microcontroller that can convert the orientation of the head-mounted display to a control signal. The system can include a motor controller that can orient a gimbal based on the control signal. The system can include a plurality of cameras on the gimbal that can stream a plurality of images to the head-mounted display. The system can include a processor on the head-mounted display that can process the plurality of images to generate a synthesized plurality of images for stereoscopic display. The system can include a display in the head-mounted display that can display the synthesized plurality of images.

These and other aspects are described in detail below. The above-mentioned information and the following detailed description include illustrative examples of various aspects, and provide an overview or framework for understanding the nature and character of the claimed aspects. The drawings provide illustration and a further understanding of the various aspects, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawing:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein;

FIGS. 2A and 2B are block diagrams each depicting a system for controlling a remote camera system by head rotation, in accordance with an illustrative embodiment;

FIGS. 3A-3D are depictions of a camera mounted gimbal in a remote camera control system controlled by head rotation, in accordance with an illustrative embodiment; and

FIG. 4 is a flow diagram depicting a method of controlling a remote camera system by head rotation.

### DETAILED DESCRIPTION

The systems and methods described herein are related to remote camera control systems that can rely on a user's head orientation as a mode of control. A head-mounted display (HMD) can be used to measure or determine the orientation of the user's head. A microcontroller can translate the orientation data from the HMD to control signals for controlling the orientation of a camera mounted gimbal. The camera mounted gimbal can have a plurality of cameras to allow for stereoscopic vision and depth perception. The cameras on the camera mounted gimbal can stream videos back to a display in the HMD. The microphones on the camera mounted gimbal can stream audio back to a speaker on the HMD. A processor on the HMD or an intermediary computing device can process the streaming video for stereoscopic vision and depth perception.

In general, remote camera control systems can be used to remotely view, monitor, or observe objects, scenes, and events in a variety of applications. Remote camera control systems can be used as a stand alone or in conjunction with other components to augment the functionality of the system. For example, the remote camera control system can be used to remotely spectate entertainment venues, such as sports games and concerts. In such settings, the remote camera control system can be attached to anywhere in the venue, such as the seating, ceiling, arena floor, stage, or elsewhere. The remote camera control system can be attached to a track in the venue, such as along the side of the arena floor or stage and can include a remote control to control the movement of the remote camera control system along the track. The remote camera control system can provide a zoom feature to zoom into the game or performance.

Another exemplary application of the remote camera control system can be the operation of remote controlled vehicles. An operator can use the remote camera control system to navigate the remote controlled vehicle through hazardous environments, such as polluted waste sites, warzones, deep sea, or outer space. In such applications, the remote camera control system can be attached to the vehicle or replace the preexisting camera system of the remote control vehicle.

In addition, the remote camera control system can be also used in telemedicine, such as tele-ICUs (Intensive Care Units). Using the remote camera control system, a medical practitioner such as a physician, psychiatrist, surgeon, or nurse, can remotely oversee multiple patients to interface, diagnose, monitor, or treat them. For example, a doctor can use the remote camera control system to monitor the health or vitals of a bedridden patient. The remote camera control system can be placed at the bedside of a patient or a platform in the patient's room. The remote camera control system can also include X-ray or thermal vision cameras used to further aid the medical practitioner's work. Further exemplary applications of the remote camera control system can include remotely checking in a child at a daycare center, monitor security of premises, and observing animals in the wild in their natural environments.

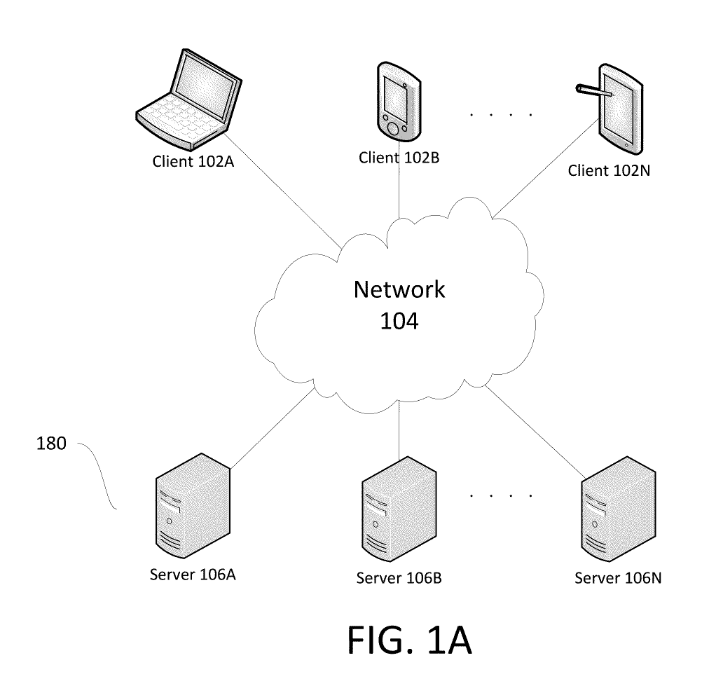

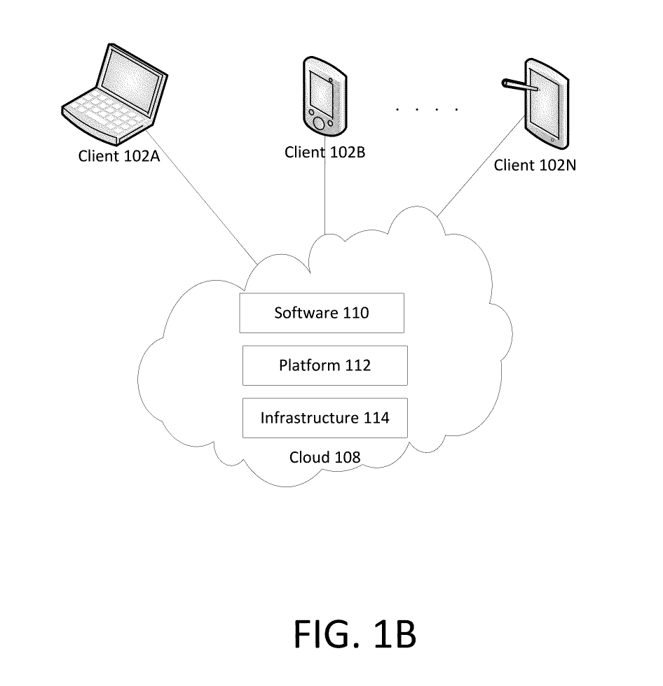

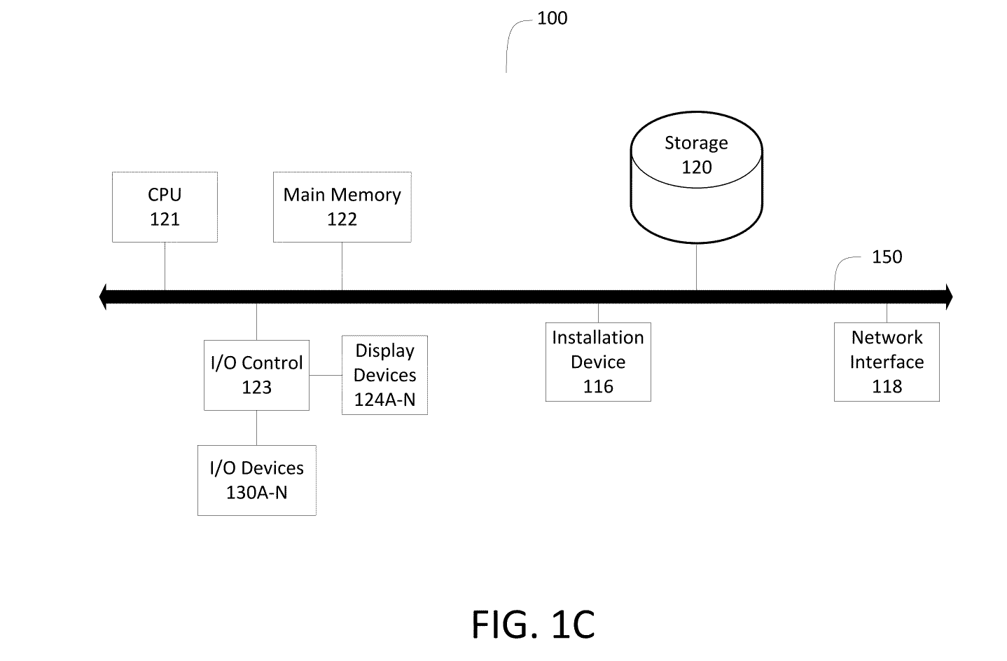

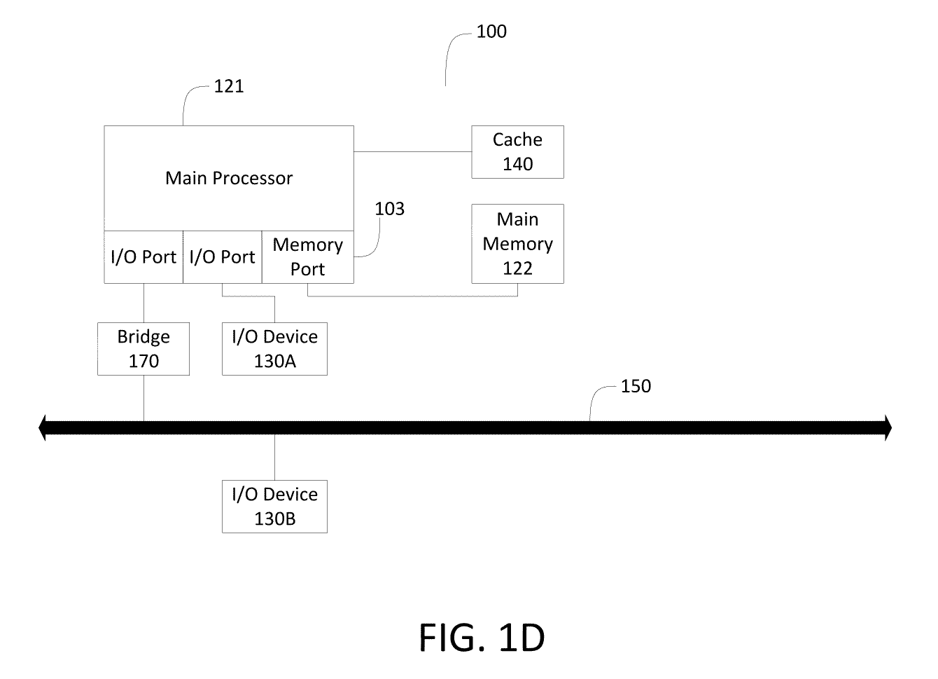

It may be helpful to first describe aspects of the operating environment as well as associated system components (e.g., hardware elements) in connection with the methods and systems described herein. Referring to FIG. 1A, an embodiment of a network environment is depicted. In brief overview, the network environment includes one or more clients 102A-102N (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106A-106N (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102A-102N.

Although FIG. 1A shows a network 104 between the clients 102 and the servers 106, the clients 102 and the servers 106 can be on the same network 104. In some embodiments, there are multiple networks 104 between the clients 102 and the servers 106. In one of these embodiments, a network 104′ (not shown) can be a private network and a network 104 can be a public network. In another of these embodiments, a network 104 can be a private network and a network 104′ a public network. In still another of these embodiments, networks 104 and 104′ can both be private networks.

The network 104 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, or 4G. The network standards can qualify as one or more generation of mobile telecommunication standards by fulfilling a specification or standards such as the specifications maintained by International Telecommunication Union. The 3G standards, for example, can correspond to the International Mobile Telecommunications-2000 (IMT-2000) specification, and the 4G standards can correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards can use various channel access methods e.g. FDMA, TDMA, CDMA, or SDMA. In some embodiments, different types of data can be transmitted via different links and standards. In other embodiments, the same types of data can be transmitted via different links and standards.

The network 104 can be any type and/or form of network. The geographical scope of the network 104 can vary widely and the network 104 can be a body area network (BAN), a personal area network (PAN), a local-area network (LAN), e.g. Intranet, a metropolitan area network (MAN), a wide area network (WAN), or the Internet. The topology of the network 104 can be of any form and can include, e.g., any of the following: point-to-point, bus, star, ring, mesh, or tree. The network 104 can be an overlay network which is virtual and sits on top of one or more layers of other networks 104′. The network 104 can be of any such network topology as known to those ordinarily skilled in the art capable of supporting the operations described herein. The network 104 can utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite can include application layer, transport layer, internet layer (including, e.g., IPv6), or the link layer. The network 104 can be a type of a broadcast network, a telecommunications network, a data communication network, or a computer network.

The network 104 can also utilize WebRTC (Web Real-Time Communications) protocol. The WebRTC can employ the ICE (Interactive Connectivity Establishment) framework that can be used to find and determine the shortest, most optimal path of connection between the clients 102 and the servers 106 via the network 104. Under the ICE framework, even if the network 104 does not allow for direct between the clients 102, the clients 102 can connect with one another directly by using endpoints provided by STUN (Session Traversal Utilities for Network Address Translation) and TURN (Traversal Using Relay Network Address Translation) servers (e.g., servers 106A-N). The ICE framework can also dynamically determine the shortest paths among the clients 102A-N and servers 106A-N connected via the network 104 using shortest path algorithms.

In some embodiments, the system can include multiple, logically-grouped servers 106. In one of these embodiments, the logical group of servers can be referred to as a server farm 180 or a machine farm 180. In another of these embodiments, the servers 106 can be geographically dispersed. In other embodiments, a machine farm 180 can be administered as a single entity. In still other embodiments, the machine farm 180 includes a plurality of machine farms 180. The servers 106 within each machine farm 180 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 180 can be stored in high-density rack systems, along with associated storage systems, and located in an enterprise data center. In this embodiment, consolidating the servers 106 in this way can improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 180 do not need to be physically proximate to another server 106 in the same machine farm 180. Thus, the group of servers 106 logically grouped as a machine farm 180 can be interconnected using a wide-area network (WAN) connection or a metropolitan-area network (MAN) connection. For example, a machine farm 180 can include servers 106 physically located in different continents or different regions of a continent, country, state, city, campus, or room. Data transmission speeds between servers 106 in the machine farm 180 can be increased if the servers 106 are connected using a local-area network (LAN) connection or some form of direct connection. Additionally, a heterogeneous machine farm 180 can include one or more servers 106 operating according to a type of operating system, while one or more other servers 106 execute one or more types of hypervisors rather than operating systems. In these embodiments, hypervisors can be used to emulate virtual hardware, partition physical hardware, virtualize physical hardware, and execute virtual machines that provide access to computing environments, allowing multiple operating systems to run concurrently on a host computer. Native hypervisors can run directly on the host computer. Hypervisors can include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors can run within an operating system on a second software level. Examples of hosted hypervisors can include VMware Workstation and VIRTUALBOX.

Management of the machine farm 180 can be de-centralized. For example, one or more servers 106 can comprise components, subsystems and modules to support one or more management services for the machine farm 180. In one of these embodiments, one or more servers 106 provide functionality for management of dynamic data, including techniques for handling failover, data replication, and increasing the robustness of the machine farm 180. Each server 106 can communicate with a persistent store and, in some embodiments, with a dynamic store.

Server 106 can be a file server, application server, web server, proxy server, appliance, network appliance, gateway, gateway server, virtualization server, deployment server, SSL VPN server, or firewall. In one embodiment, the server 106 can be referred to as a remote machine or a node. In another embodiment, a plurality of nodes 290 can be in the path between any two communicating servers.

Referring to FIG. 1B, a cloud computing environment is depicted. A cloud computing environment can provide client 102 with one or more resources provided by a network environment. The cloud computing environment can include one or more clients 102A-102N, in communication with the cloud 108 over one or more networks 104. Clients 102 can include, e.g., thick clients, thin clients, and zero clients. A thick client can provide at least some functionality even when disconnected from the cloud 108 or servers 106. A thin client or a zero client can depend on the connection to the cloud 108 or server 106 to provide functionality. A zero client can depend on the cloud 108 or other networks 104 or servers 106 to retrieve operating system data for the client device. The cloud 108 can include back end platforms, e.g., servers 106, storage, server farms or data centers.

The cloud 108 can be public, private, or hybrid. Public clouds can include public servers 106 that are maintained by third parties to the clients 102 or the owners of the clients. The servers 106 can be located off-site in remote geographical locations as disclosed above or otherwise. Public clouds can be connected to the servers 106 over a public network. Private clouds can include private servers 106 that are physically maintained by clients 102 or owners of clients. Private clouds can be connected to the servers 106 over a private network 104. Hybrid clouds 108 can include both the private and public networks 104 and servers 106.

The cloud 108 can also include a cloud based delivery, e.g. Software as a Service (SaaS) 110, Platform as a Service (PaaS) 112, and Infrastructure as a Service (IaaS) 114. IaaS can refer to a user renting the use of infrastructure resources that are needed during a specified time period. IaaS providers can offer storage, networking, servers or virtualization resources from large pools, allowing the users to quickly scale up by accessing more resources as needed. Examples of IaaS can include infrastructure and services (e.g., EG-32) provided by OVH HOSTING of Montreal, Quebec, Canada, AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers can offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers can offer the resources that PaaS provides, including storage, networking, servers, virtualization, operating system, middleware, or runtime resources. In some embodiments, SaaS providers can offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS can also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 can access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards can allow clients access to resources over HTTP, and can use Representational State Transfer (REST) protocol or Simple Object Access Protocol (SOAP). Clients 102 can access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that can be built on REST, HTTP, XML, or other protocols. Clients 102 can access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 can also access SaaS resources through smartphone or tablet applications, including, e.g., Salesforce Sales Cloud, or Google Drive app. Clients 102 can also access SaaS resources through the client operating system, including, e.g., Windows file system for DROPBOX.

In some embodiments, access to IaaS, PaaS, or SaaS resources can be authenticated. For example, a server or authentication server can authenticate a user via security certificates, HTTPS, or API keys. API keys can include various encryption standards such as, e.g., Advanced Encryption Standard (AES). Data resources can be sent over Transport Layer Security (TLS) or Secure Sockets Layer (SSL).

The client 102 and server 106 can be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 can include a storage device 120, an installation device 116, a network interface 118, an I/O controller 723 and display devices 124A-124N. I/O devices can include, for example, a keyboard and mouse. The storage device 120 can include, without limitation, an operating system and software. As shown in FIG. 1D, each computing device 100 can also include additional optional elements, e.g. a memory port 103, a bridge 170, one or more input/output devices 130A-130N (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 can be based on any of these processors, or any other processor capable of operating as described herein. The central processing unit 121 can utilize instruction level parallelism, thread level parallelism, different levels of cache, and multi-core processors. A multi-core processor can include two or more processing units on a single computing component. Examples of multi-core processors include the AMD PHENOM IIX2, INTEL CORE i5 and INTEL CORE i7.

Main memory unit 122 can include one or more memory chips capable of storing data and allowing any storage location to be directly accessed by the microprocessor 121. Main memory unit 122 can be volatile and faster than storage 120 memory. Main memory units 122 can be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 120 can be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 can be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 can be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses can be used to connect the central processing unit 121 to any of the I/O devices 130, including a PCI bus, a PCI-X bus, or a PCI-Express bus, or a NuBus. For embodiments in which the I/O device is a video display 124, the processor 121 can use an Advanced Graphics Port (AGP) to communicate with the display 124 or the I/O controller 723 for the display 124. FIG. 1D depicts an embodiment of a computer 100 in which the main processor 121 communicates directly with I/O device 130B or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130B directly.

A wide variety of I/O devices 130A-130N can be present in the computing device 100. Input devices can include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices can include video displays, graphical displays, speakers, headphones, inkjet printers, laser printers, and 3D printers.

Devices 130A-130N can include a combination of multiple input or output devices, including, e.g., Microsoft KINECT, Nintendo Wiimote for the WII, Nintendo WII U GAMEPAD, or Apple IPHONE. Some devices 130A-130N allow gesture recognition inputs through combining some of the inputs and outputs. Some devices 130A-130N provides for facial recognition which can be utilized as an input for different purposes including authentication and other commands. Some devices 130A-130N provides for voice recognition and inputs, including, e.g., Microsoft KINECT, SIRI for IPHONE by Apple, Google Now or Google Voice Search.

Additional devices 130A-130N have both input and output capabilities, including, e.g., haptic feedback devices, touchscreen displays, or multi-touch displays. Touchscreen, multi-touch displays, touchpads, touch mice, or other touch sensing devices can use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices can allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, can have larger surfaces, such as on a table-top or on a wall, and can also interact with other electronic devices. Some I/O devices 130A-130N, display devices 124A-124N or group of devices can be augment reality devices. The I/O devices can be controlled by an I/O controller 723 as shown in FIG. 1C. The I/O controller can control one or more I/O devices, such as, e.g., a keyboard 126 and a pointing device 127, e.g., a mouse or optical pen. Furthermore, an I/O device can also provide storage and/or an installation medium 116 for the computing device 100. In still other embodiments, the computing device 100 can provide USB connections (not shown) to receive handheld USB storage devices. In further embodiments, an I/O device 130 can be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124A-124N can be connected to I/O controller 723. Display devices can include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays can use, e.g. stereoscopy, polarization filters, active shutters, or autostereoscopy. Display devices 124A-124N can also be a head-mounted display (HMD). In some embodiments, display devices 124A-124N or the corresponding I/O controllers 723 can be controlled through or have hardware support for OPENGL or DIRECTX API or other graphics libraries.

In some embodiments, the computing device 100 can include or connect to multiple display devices 124A-124N, which each can be of the same or different type and/or form. As such, any of the I/O devices 130A-130N and/or the I/O controller 723 can include any type and/or form of suitable hardware, software, or combination of hardware and software to support, enable or provide for the connection and use of multiple display devices 124A-124N by the computing device 100. For example, the computing device 100 can include any type and/or form of video adapter, video card, driver, and/or library to interface, communicate, connect or otherwise use the display devices 124A-124N. In one embodiment, a video adapter can include multiple connectors to interface to multiple display devices 124A-124N. In other embodiments, the computing device 100 can include multiple video adapters, with each video adapter connected to one or more of the display devices 124A-124N. In some embodiments, any portion of the operating system of the computing device 100 can be configured for using multiple displays 124A-124N. In other embodiments, one or more of the display devices 124A-124N can be provided by one or more other computing devices 100a or 100b connected to the computing device 100, via the network 104. In some embodiments software can be designed and constructed to use another computer's display device as a second display device 124a for the computing device 100. For example, in one embodiment, an Apple iPad can connect to a computing device 100 and use the display of the device 100 as an additional display screen that can be used as an extended desktop. One ordinarily skilled in the art will recognize and appreciate the various ways and embodiments that a computing device 100 can be configured to have multiple display devices 124A-124N.

Referring again to FIG. 1C, the computing device 100 can comprise a storage device 120 (e.g. one or more hard disk drives or redundant arrays of independent disks) for storing an operating system or other related software, and for storing application software programs. Examples of storage device 120 include, e.g., hard disk drive (HDD); optical drive including CD drive, DVD drive, or BLU-RAY drive; solid-state drive (SSD); USB flash drive; or any other device suitable for storing data. Some storage devices can include multiple volatile and non-volatile memories, including, e.g., solid state hybrid drives that combine hard disks with solid state cache. Some storage device 120 can be non-volatile, mutable, or read-only. Some storage device 120 can be internal and connect to the computing device 100 via a bus 150. Some storage device 120 can be external and connect to the computing device 100 via a I/O device 130 that provides an external bus. Some storage device 120 can connect to the computing device 100 via the network interface 118 over a network 104, including, e.g., the Remote Disk for MACBOOK AIR by Apple. Some client devices 100 may not require a non-volatile storage device 120 and can be thin clients or zero clients 102. Some storage device 120 can also be used as an installation device 116, and can be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 can also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform can facilitate installation of software on a client device 102. An application distribution platform can include a repository of applications on a server 106 or a cloud 108, which the clients 102A-102N can access over a network 104. An application distribution platform can include application developed and provided by various developers. A user of a client device 102 can select, purchase and/or download an application via the application distribution platform.

Furthermore, the computing device 100 can include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.17A/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 can comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C can operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, can be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 can have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 can comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players can have other functionality, including, e.g., a gaming system or any functionality made available by an application from a digital application distribution platform. For example, the IPOD Touch can access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 are monitored, generally as part of network management. In one of these embodiments, the status of a machine can include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information can be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

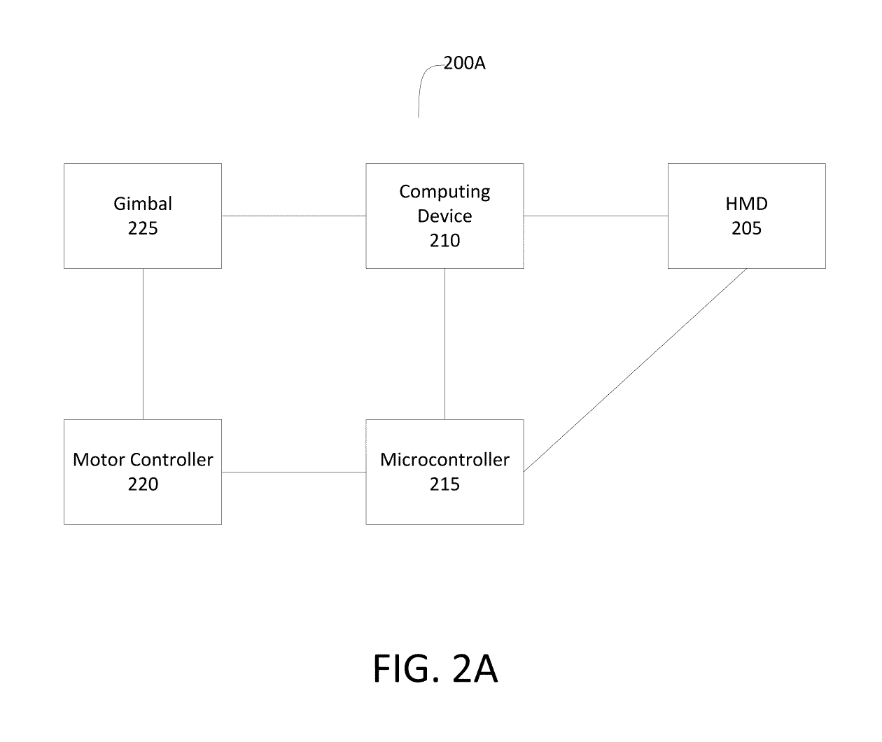

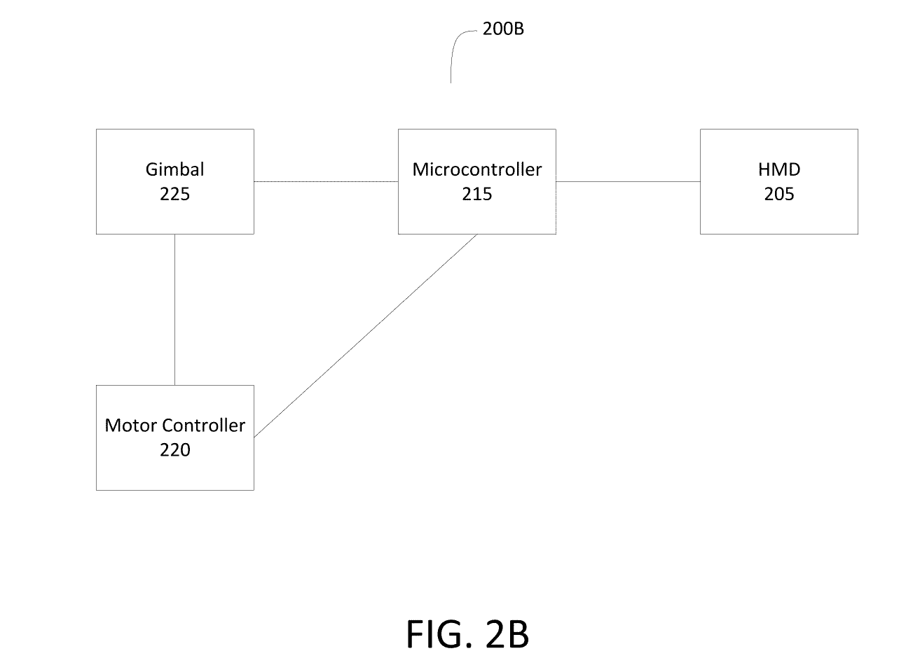

FIG. 2A is a block diagram depicting a system for controlling a remote camera system by head rotation, according to an illustrative implementation. In brief overview, the system 200A can include a head-mounted display (HMD) 205, computing device 210, microcontroller 215, motor controller 220, and camera mounted gimbal 225. The HMD 205 can transmit and receive signals from the computing device 210 and the microcontroller 215. The computing device 210 can transmit and receive signals from the camera mounted gimbal 225, microcontroller 215, and the HMD 205. The microcontroller 215 can transmit and receive signals from the motor controller 220, computing device 210, and the HMD 205. The motor controller 220 can transmit to and receive signals from the camera mounted gimbal 225 and the microcontroller 215. The camera mounted gimbal 225 can transmit and receive signals form the computing device 210 and the motor controller 220. The system 200A can interact with one or more clients 102A-N (or client device 102) or servers 106A-N via the network 104. Clients 102A-N or servers 106A-N can include one or more components of the system 200A.

The HMD 205 can include a sensor, a processor, a speaker, and a display. A user can wear the HMD 205 on the user's head and can use the HMD 205 to control the orientation, rotation, or the camera mounted gimbal 225. The orientation, movement, or rotation of the HMD 205 can control a remote camera system, such as cameras on the camera mounted gimbal 225. A user can wear the HMD 205 and can control the camera mounted gimbal 225 by rotating the user's head. The HMD 205 can be, for example, the Oculus Rift, Sony HMZ-T1, Steam VR, Razer OSVR, HTC Vive, or any other head-mounted display device suitable for controlling a remote camera system.

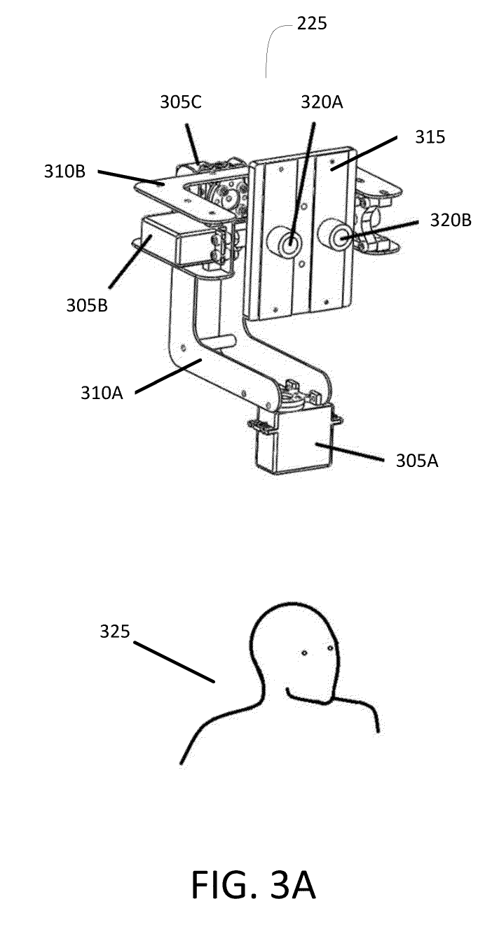

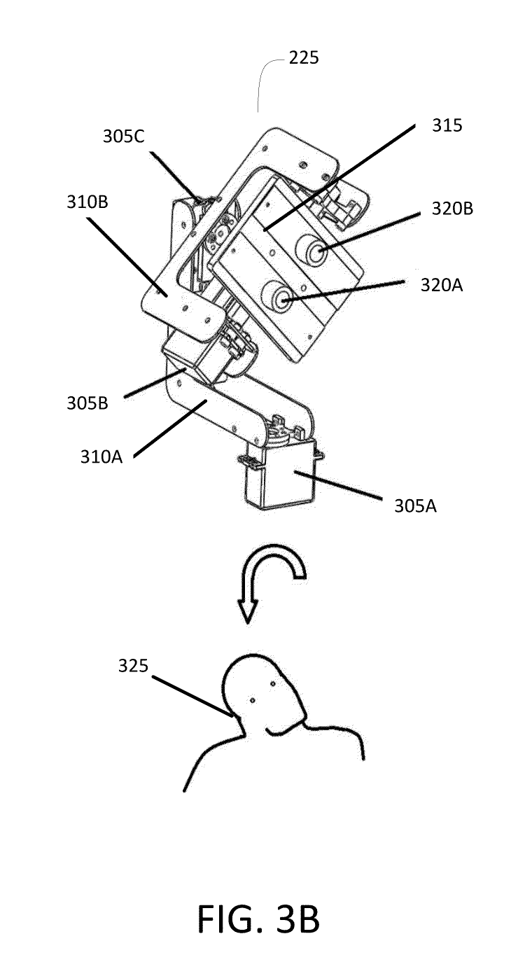

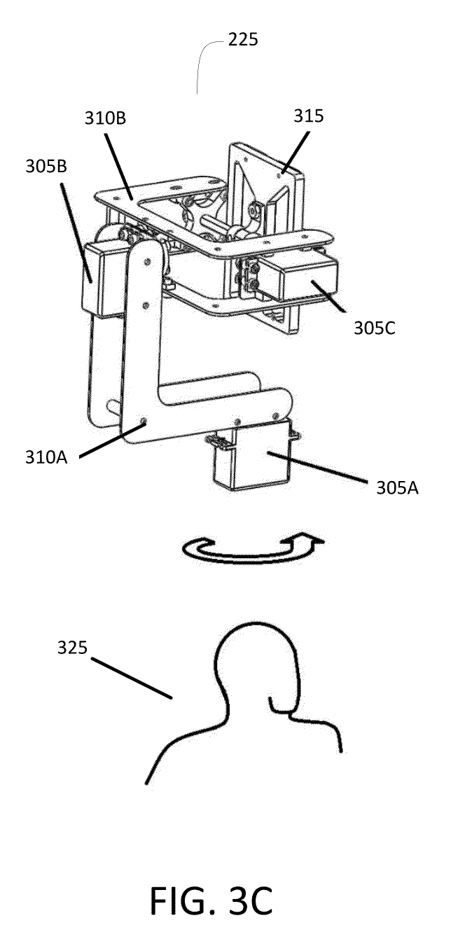

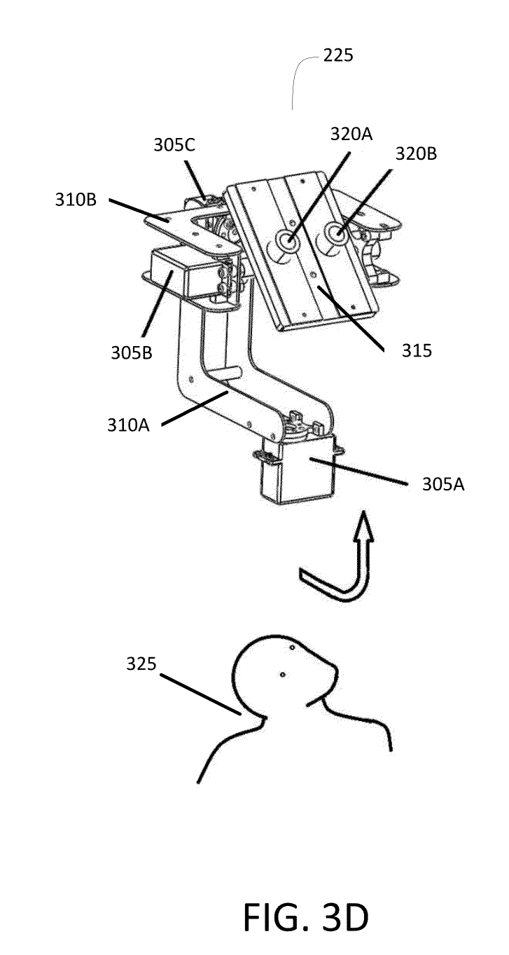

Briefly referring to FIGS. 3A-3D, shown are depictions of the camera mounted gimbal 225 for a system for controlling a camera system by head rotation, according to an illustrative embodiment. As depicted, the camera mounted gimbal 225 can include: a back arm rotation motor 305A, arm rotation motor 305B, camera plate rotation motor 305C, back arm 310A, camera arm 310B, camera plate 315, left camera 320A, and right camera 320B. The back arm rotation motor 305A can be located at the base of the camera mounted gimbal 300, and can rotate or pan the camera mounted gimbal 300 along the horizontal plane in the azimuth substantially similar to the user's head 325 (e.g., 0-3 degrees). The arm rotation motor 305B can be located at the joint between the back arm 310A and the camera arm 310B, and can rotate or pan the camera arm 310B to a tilt angle substantially similar to the user's head 325 inclination (e.g., 0-5 degrees). The camera plate rotation motor 305C can be located on the camera arm 310B, and can rotate or pan the camera plate 315 to an angle substantially similar to the user's head 325 tilt (e.g., 0-4 degrees). The motors in 305A-C can include brushless DC electric motor, brushed DC electric motor, AC synchronous motor, or inductor, or any type of motor suitable for rotating the various components of the camera mounted gimbal 225. The back arm 310A can support the rest of the camera mounted gimbal 300, and can be adjoined to the camera arm 310B, the back arm rotation motor 305A, and camera arm rotation motor 305C. The camera arm 310B can be adjoined to the back arm 310A, and can support or hold the camera plate rotation motor 305C, camera plate 315, and the cameras 320A and 320B. The camera plate 315 can be adjoined to the camera arm 310B and hold the camera plate rotation motor 305C and cameras 320A and 320B. FIGS. 3A-3D show the user 325 without the HMD 205 to clarify the user's 325 orientation.

FIG. 3A depicts the camera mounted gimbal 225 in the “home” position. In this exemplary depiction, the various components of the camera mounted gimbal 225 have not rotated. Furthermore, the camera mounted gimbal 225 is generally oriented in the same direction as the user's head 325.

FIG. 3B depicts the camera mounted gimbal 225 with the camera arm 310B rotated. In this exemplary depiction, the camera arm 310B along with the camera plate rotation motor 305B, camera plate 315, and cameras 320A and 320B has rotated or tilted to an angle same or substantially similar to the tilt angle of the user's head, while the other various components of the apparatus are in the same direction as FIG. 3A. In response to the user's head 325 tilt, the camera arm rotation motor 305C has rotated or tilted the camera arm 310C, along with the camera plate 310B, camera plate 315, and cameras 320A and 325B, to the substantially same tilt angle as the user's head 325A.

FIG. 3C depicts the camera mounted gimbal 225 rotated about the vertical axis in the azimuth. In this exemplary depiction, the back arm 310A along with the various components of the camera mounted gimbal 225 has rotated about the vertical axis along the horizontal plane to an azimuth angle substantially similar as the user's head 325 rotation, while the other various components of the camera mounted gimbal 225 have not rotated. In response to the user's head 325 rotating, the back arm rotation motor 305A has rotated the back arm 310A, thereby rotating the camera mounted gimbal 225 about the vertical axis along the horizontal to substantially the same azimuth angle as the rotation of the user's head 325.

FIG. 3D depicts the camera mounted gimbal 225 with the camera plate 315 rotated at an inclination. In this exemplary depiction, the camera plate 315 along with the cameras 320A and 320B has inclined or tilted upward to an angle substantially similar as the user's head 325 upward tilt, while the other various components of the apparatus are in the same direction as FIG. 3A. In response to the user's head 325 tilting upward, the camera plate rotation motor 305B has also inclined the camera plate 315 along with the cameras 320A and 320B to an angle substantially similar as the user's head 325 upward tilt.

FIGS. 3A-3D are for illustrative purposes, intended to explain how a camera mounted gimbal 225 can be orient as a user's head rotates in connection with HMD 205. The camera mounted gimbal 225 can include a lesser or greater number of subcomponents than shown in FIGS. 3A-3D to achieve the same functionality. For example, the camera mounted gimbal can include 3 or 4 cameras, or any number of cameras sufficient to achieve stereoscopic vision. The camera plate 315 can be round shaped, instead of a flat plate. In addition, instead of a back arm and a camera arm, a camera mounted gimbal can include a single arm with a joint along the middle of the single arm.

Referring again to FIG. 2A, the sensor on the HMD 205 can determine the orientation of the HMD 205. The sensor can include a three accelerometers, three gyroscopes, and three magnetometers. The three accelerometers can measure the movement or acceleration of the HMD 205 in the x, y, or z axis respectively. The three gyroscopes can measure the orientation of the HMD 205 along the x, y, or z axis or spin, input, or output axis respectively. The three magnetometers can measure the strength and strength and direction of the magnetic field of the earth as a compass along the x, y, or z axis of the HMD 205 respectively. The sensor can also include and interface with three light-emitting diodes (LEDs), each LED corresponding to an x, y, or z axis of the HMD 205. Each LED can pulse light at different frequencies. The light can include, for example, infrared or ultraviolet, or any other electromagnetic spectrum in the electromagnetic spectrum suitable for measuring or determining the orientation data of the HMD 205. The sensor can identify which LED the pulsed laser originated. The sensor can determine the orientation of the HMD 205 based on the LED identified. The HMD 205 can transmit the orientation of the HMD 205 as measured by the sensor to the computing device 210 or the microcontroller 215. The orientation of the HMD 205 can be measured in quaternions, cylindrical coordinates, Euler coordinates, Cartesian coordinates, or any other coordinate system suitable for measuring the orientation of the HMD 205. The orientation data of the HMD 205 can include orientation, rotation, or movement (e.g., velocity) of the HMD 205. The HMD 205 can transmit or send the orientation data from the HMD 205 to the computing device 210 or the microcontroller 215 wirelessly or via wired communications.

The processor on the HMD 205 can receive streaming video from the camera mounted gimbal 225. The streaming video can include a plurality of images taken by the camera on the camera mounted gimbal 225. The processor on the HMD 205 can receive streaming video along with audio from the camera mounted gimbal 225. The processor on the HMD 205 can receive streaming video from the camera mounted gimbal 225 wirelessly. The processor on the HMD 205 can receive streaming video from the camera mounted gimbal via wired communications. The processor on the HMD 205 can receive streaming video from the camera mounted gimbal 225 via the computing device 210. The processor on the HMD 205 can process stream video to allow for stereoscopic vision.

The processor on the HMD 205 can process the streaming video. The processor on the HMD 205 can perform any number of video or multimedia processing techniques on the process the streaming video or audio. The processor on the HMD 205 can perform video compression techniques. For example, the processor on the HMD 205 can include a video codec executing on one or more processors in the processor on the HMD 205 or as a separate component in the processor on the HMD 205 capable of compressing the streaming video. The video codec can include, for example, x265, DivX, Xvid, or any other video codecs suitable for compressing the streaming video from the camera mounted gimbal 225. The video codec can compress the streaming video from the camera mounted gimbal 225 to a format in accordance with the H.264/MPEG-4 AVC, MPEG-4 Part 2, VP9, or any other video compression formats. The processor on the HMD 205 can also perform audio compression techniques. For example, the processor on the HMD 205 can include an audio codec executing on one or more processors in the processor on the HMD 205 or as a separate component in the processor on the HMD 205 capable of compressing the streaming audio. The audio codec can compress the streaming audio from the camera mounted gimbal 225 to a format in accordance with the MPEG-4 ALS, A/52 Digital Audio Compression (AC-3), or any other audio compression formats.

The processor on the HMD 205 can perform digital signal processing techniques. For example, the processor on the HMD 205 can include a component that can upsample (or interpolate) the streaming video from the camera mounted gimbal 225, thereby increasing the sample rate of each image in the streaming video. The processor on the HMD 205 can also include a component that can downsample (or decimate) the streaming video from the camera mounted gimbal 225, thereby decreasing the number of sample points in each image of the streaming video. Responsive to a determination that each image frame of the streaming video from the camera mounted gimbal 225 has been compressively sampled, the processor on the HMD 205 can apply a compressed sensing reconstruction algorithm to reconstruct the image. The processor on the HMD 205 can perform image enhancing techniques. For example, the processor on the HMD 205 can apply a low-pass filter to attenuate or eliminate higher frequency components in each image of the streaming video. The processor on the HMD 205 can also apply high-pass filter to increase the contrast in each image of the streaming video.

The processor on the HMD 205 can also apply an any number of image warping or mosaicing techniques to synthesize the streaming videos from each camera to allow stereoscopic vision. For example, the processor on the HMD 205 can apply a projective transformation algorithm (homography) to stitch together or synthesize individual image frames of the streaming video from each camera with other frames of the streaming video from other cameras. The processor on the HMD 205 can also apply a warping technique to warp each image in the streaming video to accommodate for the curvature or any other characteristics of the lens of the display in the HMD 205 or of the lens on the camera mounted gimbal 225. For example, the characteristics of the lens of the display in the HMD 205 can include a map of affine space coordinates that specify how to correct for the chromatic aberration of the lens based on the color of the image at the coordinate when providing the streaming video for display. For each image of the streaming video from the cameras on the camera mounted gimbal 225, the processor on the HMD 205 can apply an affine transformation translating each coordinate of the image to the target coordinate. Some of the video or multimedia processing techniques can be performed on the computing device 210.

The display on the HMD 205 can display the streaming video. The display on the HMD 205 can display the processed streaming video. The display on the HMD 205 can include a lens. The lens can include particular characteristics, such as distortion or aberration. For example, the lens can exhibit distortion, such as a pincushion distortion or barrel distortion. The lens can also exhibit chromatic aberration, such that the various wavelength components of light can be spread among different locations within the lens. The lenses in the HMD 205 can include bioconvex, plano-convex, or any other type of lens suitable for displaying the processed streaming video on the HDM 205 from the camera mounted gimbal 225. The speaker on the HMD 205 can play the streaming audio. The speaker on the HMD 205 can play the processed streaming audio. The speaker on the HMD 205 can include headphones, loudspeakers, subwoofers, woofers, or any other type of electro-acoustic transducer capable of transmitting the streaming audio.

The computing device 210 can include one or more processors. The one or more processors can include the components of CPU 121 as shown in FIG. 1D. The computing device 210 can include the various components of the system 100 as shown in FIG. 1C or FIG. 1D. The computing device 210 can operate as a service in the cloud 108 as depicted in FIG. 1B. The computing device 210 can operate as one of the servers 106 or as one of the clients 102A-N interfacing with one or more other clients 102A-N as shown in FIG. 1A. Using the ICE framework, the computing device 210 or any one or more components of system 100 can direct the various signals among the components of system 200A via the shortest or most optimal path through the network 104. For example, the computing device 210 or any or more components of the system 100 can direct or redirect the streaming video from the camera mounted gimbal 225 to the HMD 205 via the shortest path through the network 104. The one or more client devices 102A-N can include a HMD 205, microcontroller 215, motor controller 220, and camera mounted gimbal 225.

The computing device 210 can receive orientation data from the HMD 205 either wirelessly or via wired communications. The computing device 210 can convert the orientation of the HMD 205 represented in one coordinate system to another coordinate system. For example, if the orientation data of the HMD 205 is represented in quaternions (i, j, k), the computing device 210 can convert the orientation data into Euler angles (α, β, γ). The computing device 210 can send or transmit the converted orientation data to the microcontroller 215. The computing device 210 can also receive orientation data from the camera mounted gimbal 225. The computing device 210 can adjust the converted orientation based on the orientation data from the camera mounted gimbal 225. For example, suppose the orientation data from the camera mounted gimbal 225 indicates that the camera mounted gimbal 225 is oriented at λ, μ, σ in Euler angle notation. Further suppose that the camera mounted gimbal 225 is moving in the opposite direction at velocity k as the received orientation of the HMD 205 α, β, γ. In this example, the computing device 210 can adjust the orientation data to be sent to the microcontroller to α′, β′, γ′ to account for the speed of rotation of the camera mounted gimbal 225 and to prevent overshooting the intended orientation.

The computing device 210 can receive the streaming video from the camera mounted gimbal 225. The computing device 210 can receive streaming video along with audio from the camera mounted gimbal 225. The computing device 210 can receive streaming video from the camera mounted gimbal 225 wirelessly. The computing device 210 can receive streaming video from the camera mounted gimbal via wired communications. The computing device 210 can process the streaming video.

The computing device 210 can perform any number of video or multimedia processing techniques on the streaming video or audio. The computing device 210 can perform video compression techniques. For example, the computing device 210 can include a video codec executing on one or more processors in the computing device 210 or as a separate component in the computing device 210 capable of compressing the streaming video. The video codec can include, for example, x265, DivX, Xvid, or any other video codecs suitable for compressing the streaming video from the camera mounted gimbal 225. The video codec can compress the streaming video from the camera mounted gimbal 225 to a format in accordance with the H.264/MPEG-4 AVC, MPEG-4 Part 2, VP9, or any other video compression formats. The computing device 210 can also perform audio compression techniques. For example, the computing device 210 can include an audio codec executing on one or more processors in the computing device 210 or as a separate component in the computing device 210 capable of compressing the streaming audio. The audio codec can compress the streaming audio from the camera mounted gimbal 225 to a format in accordance with the MPEG-4 ALS, A/52 Digital Audio Compression (AC-3), or any other audio compression formats.

The computing device 210 can perform digital signal processing techniques. For example, the computing device 210 can include a component that can upsample (or interpolate) the streaming video from the camera mounted gimbal 225, thereby increasing the sample rate of each image in the streaming video. The computing device 210 can also include a component that can downsample (or decimate) the streaming video from the camera mounted gimbal 225, thereby decreasing the number of sample points in each image of the streaming video. Responsive to a determination that each image frame of the streaming video from the camera mounted gimbal 225 has been compressively sampled, the processor on the HMD 205 can apply an compressed sensing reconstruction algorithm to reconstruct the image. The computing device 210 can perform image enhancing techniques. For example, the computing device 210 can apply a low-pass filter to attenuate or eliminate higher frequency components in each image of the streaming video. The computing device 210 can also apply high-pass filter to increase the contrast in each image of the streaming video.

The computing device 210 can also apply an any number of image warping or mosaicing techniques to synthesize the streaming videos from each camera to allow stereoscopic vision. For example, the computing device 210 can apply a projective transformation algorithm (homography) to stitch together or synthesize individual image frames of the streaming video from each camera with other frames of the streaming video from other cameras. The computing device 210 can also apply a warping technique to warp each image in the streaming video to accommodate for the curvature or any other characteristics of the lens of the display in the HMD 205 or of the lens on the camera mounted gimbal 225. For example, the characteristics of the lens of the display in the HMD 205 can include a map of affine space coordinates that specify how to correct for the chromatic aberration of the lens based on the color of the image at the coordinate when providing the streaming video for display. For each image of the streaming video from the cameras on the camera mounted gimbal 225, the computing device 210 can apply an affine transformation translating each coordinate of the image to the target coordinate. In this example, the computing device 210 can apply similar algorithms to correct for the curvature of the lens in the camera mounted gimbal 225.

Some of the video or multimedia processing techniques can be performed on the processor in the HMD 205. For example, the computing device 210 can be set to compress the streaming video while the processor in the HMD 205 can be configured to apply image enhancing techniques. The computing device 210 can also dynamically offload some of the video or multimedia processing techniques to the microcontroller 215 or the processors in the HMD 205 based on a number of performance measures. For example, suppose that by default the processor in the HMD 205 executes the warping algorithm while the computing device 210 performs the video compression. Responsive to a determination that the buffer in the processor in the HMD 205 is full, the computing device 210 can also process the streaming video applying warping algorithms until receiving an indication that the buffer in the processor in the HMD 205 has availability.

In addition, some or all the functionalities of the computing device 210 can be incorporated into the microcontroller 215, yielding to system 200B as depicted in FIG. 2B. Functionalities of the computing device 210 that can be incorporated into the microcontroller 215 include receiving streaming video from the camera mounted gimbal 225, performing any number of video or multimedia processing techniques on the streaming video or audio, performing image enhancement techniques, and applying warping algorithms to account for the characteristics of the lens in the HMD 205. The microcontroller 215 in system 200B can also retain the functionalities of the microcontroller 215 as the component functions in system 200A. Conversely, some or all of the functionalities of the microcontroller 215 can be incorporated into the computing device 210, also yielding to system 200B as depicted in FIG. 2B. In brief overview of FIG. 2B, the system 200B can include a head-mounted display (HMD) 205, microcontroller 215, motor controller 220, and camera mounted gimbal 225. The HMD 205 can transmit and receive signals from the computing device 210 and the microcontroller 215. The microcontroller 215 can transmit and receive signals from the motor controller 220, camera gimbal apparatus 225, and the HMD 205. The motor controller 220 can transmit to and receive signals from the camera mounted gimbal 225 and the microcontroller 215. The camera mounted gimbal 225 can transmit and receive signals from the microcontroller 215 and the motor controller 220. System 200B can interact with one or more clients 102A-N (or client device 102) or servers 106A-N via the network 104.

The microcontroller 215 can include one or more processors. The one or more processors can include the components of CPU 121 as shown in FIG. 1D. The microcontroller 215 can include the various components of the system 100 as shown in FIG. 1C or 1D. The microcontroller 215 can convert the orientation of the HMD 205 to a control signal. The control signal can be a pulse-width modulated (PWM) signal or a signal compliant with the universal asynchronous receiver/transmitter (UART) or inter-integrated circuit (I2C) communication standard. For example, when the microcontroller 215 receives the orientation data in Euler angle representation from the computing device 210 or the HMD 205, the microcontroller 215 can convert the three-dimensional (α, β, γ) representation into three respective PWM signals for the motor controller 220. The microcontroller 215 can be, for example, the Arduino Uno, Texas Instruments Piccolo C28x, or any other microcontroller suitable for interfacing with a motor controller.

The motor controller 220 can control the orientation of the camera mounted gimbal 225 based on the control signal. The motor controller 220 can control the speed and rotation of one or more motors on the camera mounted gimbal 225 based on the control signal. The motor controller 220 can receive a control signal from the microcontroller 215 to orient or rotate the camera mounted gimbal 225. For example, responsive to receiving a control signal from the microcontroller 215 indicating an upward tilt orientation (e.g., decrease in β in Euler angles) of the HMD 205, the motor controller 220 can apply a voltage or a signal to one or more of the motors on the camera mounted gimbal 225 to tilt upward to the same degree. The motor controller 220 can control the speed and rotation of one or more motors on the camera mounted gimbal 225 based on the movement or rotation of the HMD 205 indicated via the control signal. For example, responsive to receiving a control signal from the microcontroller 215 indicating a downward tilt orientation at a certain time rate (e.g., 2.3 seconds), the motor controller can apply a voltage or signal to the one or more motors on the camera mounted gimbal 225 to tilt downward at the indicated orientation and rate.

The motor controller 220 can receive orientation data of the camera mounted gimbal 225 from an internal measurement unit of the camera mounted gimbal 225. The motor controller 220 can adjust the signal or voltage to apply to one or more motors on the camera mounted gimbal 225 based on the received orientation data. For example, suppose the motor controller 220 receives a control signal from the microcontroller 215 indicating a downward tilt (e.g., increase in β by μ in Euler angles) of the HMD 205. Further suppose that the motor controller 220 receives orientation data from the camera mounted gimbal 225 indicating that the camera mounted gimbal 225 is substantially similar in orientation (e.g., β+μ<0.01π). In this example, the motor controller 220 can adjust the signal or voltage applied to the motors of the camera mounted gimbal 225 accordingly to prevent the camera mounted gimbal 225 from overshooting the orientation indicated by the control signal. The motor controller 220 can adjust the signal or voltage to apply to one or more motors on the camera mounted gimbal 225 based on the speed or rotation data of the camera mounted gimbal 225 measured by internal measurement unit of the camera mounted gimbal 225. For example, suppose the camera mounted gimbal 225 is orienting toward a downward tilt (e.g., increase in β by μ in Euler angles) at a certain rate (e.g., 0.3 seconds). In addition, suppose that the motor controller 220 receives a control signal from the microcontroller 215 indicating an upward tilt (e.g., increase in β by σ) of the HMD 205. In this example, responsive to receiving the orientation data from the camera mounted gimbal and to receiving a control signal from the microcontroller 215, the motor controller 220 can adjust the signal or voltage applied to the one or more motors of the camera mounted gimbal 225 to match the specified orientation.

The camera mounted gimbal 225 can include an internal measurement unit, one or more motors, a plurality of cameras, one or more microphones, and any number of mechanical components to orient, rotate, or move the plurality of cameras. The internal measurement unit on the camera mounted gimbal 225 can include three accelerometers, three gyroscopes, and three magnetometers. The three accelerometers can measure the movement or acceleration of the camera mounted gimbal 225 in the x, y, or z axis respectively. The three gyroscopes can measure the orientation of the HMD 205 along the x, y, or z axis or spin, input, or output axis respectively. The three magnetometers can measure the strength and direction of the magnetic field of the earth as a compass along the x, y, or z axis of the camera mounted gimbal 225 respectively.

The cameras on the camera mounted gimbal 225 can be used to take the streaming videos. The cameras on the camera mounted gimbal 225 can be mounted on the camera mounted gimbal 225. Each camera on the camera mounted gimbal 225 can include a digital single-lens reflex camera, mirrorless interchangeable lens camera, digital single lens translucent camera, lensless camera, or any other type of camera suitable for streaming images or video to the HMD 205. The image sensor in each camera on the camera mounted gimbal 225 can include a metal-oxide semiconductor (CMOS), N-type metal-oxide semiconductor (NMOS), or a charge-coupled device (CCD). The image sensor in each camera on the camera mounted gimbal 225 can sample the entire image in each frame of the streaming video. The image sensor in each camera on the camera mounted gimbal 225 can apply compressive sensing techniques to lower the number of samples in each image frame of the streaming video. The cameras on the camera mounted gimbal 225 can send or transmit the streaming video taken either to the computing device 210 or the HMD 205.

The one or more microphones on the camera mounted gimbal 225 can be used to take streaming audio. The one or more microphones can be mounted on the camera mounted gimbal 225. The one or more microphones on the camera mounted gimbal 225 can include condenser microphones, electret microphones, microelectromechanical system microphones, piezoelectric microphones, dynamic microphones, or any type of microphone that can transduce sound arriving at the microphone into an electric signal. The polar pattern of the one or more microphones on the camera mounted gimbal 225 can include unidirectional, bidirectional, cardioid, hypercardiod, or any other pattern.

The mechanical components on the camera mounted gimbal 225 can include mechanical arms with any number of motors. Forms that the mechanical arms can be include a Gantry robot arm, a polar or spherical robot arm, cylindrical robot arm, or any other suitable form for orienting the cameras on the camera mounted gimbal 225 based on the orientation of the HMD 205. The motors on the camera mounted gimbal 225 can include brushless DC electric motor, brushed DC electric motor, AC synchronous motor, or inductor, or any type of motor suitable for rotating the various components of the camera mounted gimbal 225.

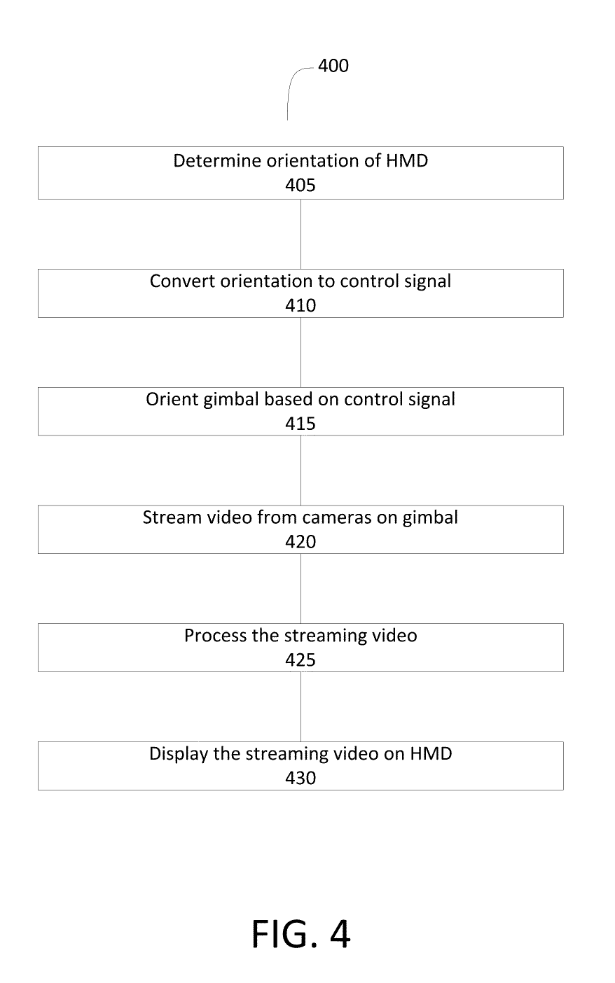

FIG. 4 depicts a workflow or method 400 of controlling a remote camera system by head rotation. The method 400 can be performed or executed by one or more components of the system 100 as depicted in FIG. 1C or 1D. The method 400 can be performed or executed by one or more components in the system 200A as depicted in FIG. 2A or 2B. The method 400 can be performed or executed upon a condition precedent. For example, upon the determination that the HMD 205 has changed orientation from the previous orientation, the system 200A can execute one or more actions in method 400.

The remote camera control system can determine the orientation of a head-mounted device (HMD) (ACT 405). The remote camera control system can determine the orientation of the HMD based on the sensors on the HMD (e.g., HMD 205 of the system 200). The sensors on the HMD can include a three accelerometers, three gyroscopes, and three magnetometers. The three accelerometers can measure the movement or acceleration of the HMD in the x, y, or z axis respectively. The three gyroscopes can measure the orientation of the HMD along the x, y, or z axis or spin, input, or output axis respectively. The three magnetometers can measure the strength and direction of the magnetic field of the earth as a compass along the x, y, or z axis of the HMD respectively. The sensor can also include and interface with three light-emitting diodes (LEDs), each LED corresponding to an x, y, or z axis of the HMD. Each LED can pulse light at different frequencies. The light can include, for example, infrared or ultraviolet, or any other electromagnetic spectrum in the electromagnetic spectrum suitable for measuring or determining the orientation data of the HMD. The sensor can identify which LED the pulsed laser originated. The sensor can determine the orientation of the HMD based on the LED identified. The HMD can transmit the orientation of the HMD as measured to any one or more components of the remote camera control system. The orientation of the HMD can be measured in quaternions, cylindrical coordinates, Euler coordinates, Cartesian coordinates, or any other coordinate system suitable for measuring the orientation of the HMD. The orientation of the HMD can include orientation, rotation, or movement (e.g., velocity) of the HMD. The remote camera control system (e.g., computing device 210 in system 200A) can convert the orientation of the HMD represented in one coordinate system to another coordinate system. For example, if the orientation data of the HMD is represented in quaternions (i, j, k), the remote camera control system can convert the orientation data into Euler angles (α, β, γ). The remote camera control system can also incorporate feedback from a camera mounted gimbal (e.g., camera mounted gimbal 225 in the system 200A or camera gimbal apparatus 300). The remote camera control system can adjust the converted orientation or control signal based on the feedback from the camera mounted gimbal. For example, suppose the orientation data from the camera mounted gimbal indicates that the camera mounted gimbal is oriented at λ, β, σ in Euler angle notation. Further suppose that the camera mounted gimbal is moving in the opposite direction at velocity k as the received orientation of the HMD α, β, γ. The remote camera control system can adjust the orientation data to α′, β′, γ′ to account for the speed of rotation of the camera mounted gimbal and to prevent overshooting the intended orientation.

The remote camera control system can convert the orientation of the HMD to a control signal (ACT 410). The remote camera control system (e.g., computing device 210 in the system 200) can convert the orientation of the HMD to a control signal. The control signal can be a pulse-width modulated (PWM) signal or a signal compliant with the universal asynchronous receiver/transmitter (UART) or inter-integrated circuit (I2C) communication standard. For example, if the orientation data in Euler angle representation, the remote camera control system can convert the three-dimensional (α, β, γ) representation into three respective PWM signals for the motor controller or one or more motors on the camera mounted gimbal.

The remote camera control system can orient a camera mounted gimbal based on the control signal (ACT 415). The remote camera control system (e.g., motor controller 220 in system 200) can control the orientation of the camera mounted gimbal (e.g., camera mounted gimbal 225 in system 200A or camera gimbal apparatus 300) based on the control signal. The remote camera control system can control the speed and rotation of one or more motors on the camera mounted gimbal based on the control signal. The remote camera control system can receive a control signal (e.g., from the microcontroller 215) to orient or rotate the camera mounted gimbal. For example, responsive to receiving a control signal indicating an upward tilt orientation (e.g., decrease in β in Euler angles) of the HMD, the remote camera control system can apply a voltage or a signal to one or more of the motors on the camera mounted gimbal to tilt upward to the same degree. The remote camera control system control the speed and rotation of one or more motors on the camera mounted gimbal based on the movement or rotation of the HMD indicated via the control signal. For example, responsive to receiving a control signal indicating a downward tilt orientation at a certain time rate (e.g., 2.3 seconds), the motor controller can apply a voltage or signal to one or more motors on the camera mounted gimbal to tilt downward at the indicated orientation and rate. The remote camera control system can adjust the signal or voltage to apply to one or more motors on the camera mounted gimbal based on the received orientation data. For example, suppose the remote camera control system receives a control signal indicating a downward tilt (e.g., increase in β by μ in Euler angle notation) of the HMD. Further suppose that the remote camera control system receives orientation data from the camera mounted gimbal 225 indicating that the camera mounted gimbal is substantially similar in orientation (e.g., β+μ<0.01π). In this example, the remote camera control system can adjust the signal or voltage applied to the motors of the camera mounted gimbal accordingly to prevent the camera mounted gimbal from overshooting the orientation indicated by the control signal. The remote camera control system can adjust the signal or voltage to apply to one or more motors on the camera mounted gimbal based on the speed or rotation data of the camera mounted gimbal from the camera mounted gimbal. For example, suppose the camera mounted gimbal is orienting toward a downward tilt (e.g., increase in β by μ in Euler angle notation) at a certain rate (e.g., 0.3 seconds). In addition, suppose that the remote camera control system receives a control signal indicating an upward tilt (e.g., increase in β by σ) of the HMD. In this example, responsive to receiving the orientation data from the camera mounted gimbal and to receiving a control signal, the remote camera control system can adjust the signal or voltage applied to the one or more motors of the camera mounted gimbal to match the orientation of the HMD.

The remote camera control system can stream video from the cameras on the camera mounted gimbal (ACT 420). The cameras on the camera mounted gimbal of the remote camera control system can be used to take the streaming videos. Each camera on the camera mounted gimbal can include a digital single-lens reflex camera, mirrorless interchangeable lens camera, digital single lens translucent camera, lensless camera, or any other type of camera suitable for streaming images or video to the HMD. The image sensor in each camera on the camera mounted gimbal can include a metal-oxide semiconductor (CMOS), N-type metal-oxide semiconductor (NMOS), or a charge-coupled device (CCD). The image sensor in each camera on the camera mounted gimbal can sample the entire image in each frame of the streaming video. The image sensor in each camera on the camera mounted gimbal can apply compressive sensing techniques to lower the number of samples in each image frame of the streaming video. The cameras on the camera mounted gimbal can send or transmit the streaming video taken to the HMD.

The remote camera control system can process the streaming video (ACT 425). The remote camera control system (e.g., processor on the HMD 205 or the computing device 200 in the system 200) can perform any number of video or multimedia processing techniques on the process the streaming video or audio. The remote camera control system can perform video compression techniques. For example, the remote camera control system can include a video codec executing on one or more processors in the remote camera control system or as a separate component in the system capable of compressing the streaming video. The video codec can include, for example, x265, DivX, Xvid, or any other video codecs suitable for compressing the streaming video from the camera mounted gimbal. The video codec can compress the streaming video from the camera mounted gimbal to a format in accordance with the H.264/MPEG-4 AVC, MPEG-4 Part 2, VP9, or any other video compression formats. The remote camera control system can also perform audio compression techniques. For example, the remote camera control system can include an audio codec executing on one or more processors in the remote camera control system or as a separate component capable of compressing the streaming audio. The audio codec can compress the streaming audio from the camera mounted gimbal to a format in accordance with the MPEG-4 ALS, A/52 Digital Audio Compression (AC-3), or any other audio compression formats.

The remote camera control system can perform digital signal processing techniques. For example, the remote camera control system can include a component that can upsample (or interpolate) the streaming video from the camera mounted gimbal, thereby increasing the sample rate of each image in the streaming video. The remote camera control system can also include a component that can downsample (or decimate) the streaming video from the camera mounted gimbal, thereby decreasing the number of sample points in each image of the streaming video. Responsive to a determination that each image frame of the streaming video from the camera mounted gimbal has been compressively sampled, the remote camera control system can apply a compressed sensing reconstruction algorithm to reconstruct the image. The remote camera control system can perform image enhancing techniques. For example, the remote camera control system can apply a low-pass filter to attenuate or eliminate higher frequency components in each image of the streaming video. The remote camera control system can also apply high-pass filter to increase the contrast in each image of the streaming video.

The remote camera control system can also apply an any number of image warping or mosaicing techniques to synthesize the streaming videos from each camera to allow stereoscopic vision. For example, the remote camera control system can apply a projective transformation algorithm (homography) to stitch together or synthesize individual image frames of the streaming video from each camera with other frames of the streaming video from other cameras. The remote camera control system can also apply a warping technique to warp each image in the streaming video to accommodate for the curvature or any other characteristics of the lens of the display in the HMD or of the lens on the camera mounted gimbal. For example, the characteristics of the lens of the display in the HMD can include a map of affine space coordinates that specify how to correct for the chromatic aberration of the lens based on the color of the image at the coordinate when providing the streaming video for display. For each image of the streaming video from the cameras on the camera mounted gimbal, the remote camera control system can apply an affine transformation translating each coordinate of the image to the target coordinate.

The remote camera control system can display the streaming video on the HMD (ACT 430). The display on the HMD can display the processed video. The display on the HMD can include a lens. The lens can include particular characteristics, such as distortion or aberration. For example, the lens can exhibit distortion, such as a pincushion distortion or barrel distortion. The lenses in the HMD can be bioconvex, plano-convex, or any other type of lens suitable for displaying the processed streaming video on the HDM from the camera mounted gimbal. The speaker on the HMD can play the streaming audio. The speaker on the HMD can play the processed streaming audio. The speaker on the HMD can include headphones, loudspeakers, subwoofers, woofers, or any other type of electro-acoustic transducer capable of transmitting the streaming audio.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer employed to implement at least a portion of the functionality described herein may comprise a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of controlling a remote camera system by head rotation, comprising:
determining, by a sensor on a head-mounted display device, an orientation of the head-mounted display;
converting, by a microcontroller, the orientation of the head-mounted display to a control signal;
orienting, by a motor controller, a gimbal based on the control signal;
streaming, by a plurality of cameras on the gimbal, a plurality of images to the head-mounted display;
processing, by a processor on the head-mounted display, the plurality of images to generate a synthesized plurality of images for stereoscopic display; and
displaying, by a display in the head-mounted display, the synthesized plurality of images.

2. The method of claim 1, comprising:
determining, by the sensor on the head-mounted display, the orientation of the head-mounted display represented in a first representation; and
converting, by a computing device having one or more processors, the orientation of the head-mounted display from the first representation to a second representation.

3. The method of claim 2, comprising:
converting, by the microcontroller, the second representation to the control signal.

4. The method of claim 1, comprising:
converting, by the microcontroller, the orientation of the head-mounted display to the control signal, the control signal comprising a pulse-width modulated signal.

5. The method of claim 1, comprising:
determining, by a measurement unit on the gimbal, a first orientation of the gimbal; and
determining, by the motor controller, a second orientation corresponding to the control signal.

6. The method of claim 4, comprising:
determining, by the motor controller, an adapted control signal to apply to orient the gimbal from the first orientation to the second orientation.

7. The method of claim 1, comprising:
processing, by the processor on the head-mounted display, the plurality of images by warping the plurality of images to account for display lens characteristics of the head-mounted display.

8. The method of claim 1, comprising:
streaming, by the plurality of cameras on the gimbal comprising a first camera and a second camera, the plurality of images to the head-mounted display.

9. The method of claim 1, comprising:
rotating, by the motor controller, the gimbal based on the control signal; and
orienting, by the motor controller, the plurality of cameras based on the control signal.

10. The method of claim 1, comprising:
streaming, by a microphone on the gimbal, audio to the head-mounted display.

11. A system for controlling a remote camera system by head rotation, comprising:
a sensor on a head-mounted display that determines an orientation of the head-mounted display;
a microcontroller that converts the orientation of the head-mounted display to a control signal;
a motor controller that orients a gimbal based on the control signal;
a plurality of cameras on the gimbal that streams a plurality of images to the head-mounted display;
a processor on the head-mounted display that processes the plurality of images to generate a synthesized plurality of images for stereoscopic display; and
a display in the head-mounted display that displays the synthesized plurality of images.

12. The system of claim 11, comprising:
the sensor on the head-mounted display determines the orientation of the head-mounted display represented in a first representation; and
a computing device having one or more processors that converts the orientation of the head-mounted display from the first representation to a second representation.

13. The system of claim 12, wherein the microcontroller converts the second representation to the control signal.

14. The system of claim 11, wherein the microcontroller converts the orientation of the head-mounted display to the control signal comprising a pulse-width modulated signal.

15. The system of claim 11, comprising:
a measurement unit on the gimbal that determines a first orientation of the gimbal;
the motor controller that determines a second orientation corresponding to the control signal.

16. The system of claim 15, wherein the motor controller determines an adapted control signal to apply to orient the gimbal from the first orientation to the second orientation.

17. The system of claim 11, wherein the processor on the head-mounted display processes the plurality of images by warping the plurality of images to account for display lens characteristics of the head-mounted display.

18. The system of claim 11, wherein the plurality of cameras comprise a first camera and a second camera.

19. The system of claim 11, wherein the motor controller rotates the gimbal based on the control signal and orients the plurality of cameras based on the control signal.

20. The system of claim 11, comprising a microphone on the gimbal that streams audio to the head-mounted display.
